(19) United States
(12) Patent Application Publication
(10) Pub. No.: US 2024/0262396 A1
(43) Pub. Date: Aug. 8, 2024

(54) RAIL VEHICLE

(71) Applicant: BYD COMPANY LIMITED, SHENZHEN (CN)

(72) Inventors: Yuhong XU, Shenzhen (CN); Junjie LIU, Shenzhen (CN); Guangbing MAO, Shenzhen (CN)

(21) Appl. No.: 18/622,317

(22) Filed: Mar. 29, 2024

Related U.S. Application Data
(63) Continuation of application No. PCT/CN2022/126475, filed on Oct. 20, 2022.

(30) Foreign Application Priority Data
Dec. 21, 2021 (CN) 202111574481.3

(51) Int. Cl. B61F 5/50

(52) U.S. Cl. CPC B61F 5/50

(57) ABSTRACT

A rail vehicle includes a bogie, multiple wheels, a chassis, and a carriage. The wheels are disposed on the bogie. The chassis is disposed on the bogie and connected to the bogie through a first suspension. The carriage is disposed on the chassis and connected to the chassis through a second suspension.

### CROSS-REFERENCE TO RELATED APPLICATIONS

The application is a continuation application of International Patent Application No. PCT/CN2022/126475 filed on Oct. 20, 2022, which is based on and claims priority to and benefits of Chinese Patent Application No. 202111574481.3, filed on Dec. 21, 2021. The entire content of all of the above-referenced applications is incorporated herein by reference.

### FIELD

The present disclosure relates to the field of rail vehicles, and in particular, to a rail vehicle.

### BACKGROUND

In the related art, a passenger compartment of a conventional rail vehicle is integrated with a chassis and directly connected to a bogie, which limits a speed increase of the vehicle, and the stability of the vehicle is poor. When the vehicle undergoes speed adjustment, the passenger compartment shakes accordingly, resulting in low comfort for passengers on board.

### SUMMARY

The present disclosure resolves at least one of the technical problems existing in the related art. Therefore, the present disclosure provides a rail vehicle having rubber tires. In the rail vehicle, by adding a second suspension between a carriage and a bogie, a vibration damping effect for the carriage is further improved, resolving a stability problem of the vehicle during high-speed operation.

According to a first aspect of the present disclosure, the rail vehicle includes a bogie, wheels, a chassis, and a carriage. The wheels are disposed on the bogie. The chassis is disposed on the bogie and connected to the bogie through a first suspension. The carriage is disposed on the chassis and connected to the chassis through a second suspension.

In an embodiment, the second suspension includes: a vibration damping member, where a first end of the vibration damping member is connected to the chassis; a first installation portion disposed at a second end of the vibration damping member; and a second installation portion disposed at a bottom of the carriage and detachably connected to the first installation portion.

In an embodiment, at least one of the first installation portion and the second installation portion is configured to be a magnetic absorption member.

In an embodiment, the chassis includes: a first support area, where multiple suspension installation points are disposed in the first support area, the second suspension is disposed at a suspension installation point of the suspension installation points, and the carriage is detachably disposed in the first support area by the second suspension; and a second support area disposed at a front portion and/or a rear portion of the first support area, where a cab is defined by the second support area and a hood of the carriage.

In an embodiment, the wheels include multiple pairs, wheels of each pair are respectively disposed on two sides of the bogie in a width direction of the rail vehicle.

In an embodiment, the rail vehicle further includes a wheel avoidance compartment that protrudes toward the carriage and is configured to accommodate a wheel, where the wheel avoidance compartment is formed on a side of the first support area, and at least one seat is disposed on the wheel avoidance compartment.

In an embodiment, the wheel avoidance compartment includes a top plate and a side plate, the side plate is connected to an end of the top plate and extends toward a rail beam, the top plate and the side plate define an accommodating chamber configured to accommodate a wheel, and one of the suspension installation points is disposed on the top plate or the side plate.

In an embodiment, the rail vehicle further includes: a pair of horizontal wheels disposed on the bogie, where the horizontal wheels are supported on side surfaces of an escape passage of a rail beam.

In an embodiment, the rail vehicle further includes a load support position disposed on the chassis, where the load support position is configured to support a load.

In an embodiment, the rail vehicle further includes a third suspension disposed between the wheels and the bogie.

According to the present disclosure, in the rail vehicle, by adding the second suspension between the carriage and the bogie, the carriage and the bogie may be separated. In addition, the first suspension is further arranged/disposed between the chassis and the bogie, and the first suspension and the second suspension may provide vibration damping for the vehicle when the vehicle undergoes speed adjustment, so that the stability problem of the vehicle during high-speed operation is resolved, and a speed increase of the vehicle is no longer limited to the stability of the vehicle.

According to a second aspect of the present disclosure, a rail system includes the rail vehicle of the first aspect and a rail beam. The rail beam is configured to support the rail vehicle. The rail beam includes a walking surface that supports the wheels, and an escape passage concaving downward formed on the walking surface.

Additional aspects and advantages of the present disclosure will be given in the following description, some of which will become apparent from the following description or may be learned from the practice of the present disclosure.

### BRIEF DESCRIPTION OF THE DRAWINGS

FIG. 1 is a cross section view of a rail vehicle according to an embodiment of the present disclosure;

FIG. 2 is another cross section view of a rail vehicle according to an embodiment of the present disclosure;

FIG. 3 is another cross section view of a rail vehicle according to an embodiment of the present disclosure;

FIG. 4 is a bottom view of a carriage according to an embodiment of the present disclosure;

FIG. 5 is a structural diagram of a second suspension according to an embodiment of the present disclosure; and

FIG. 6 is a schematic diagram of a structure of a straddle-type rail vehicle according to an embodiment of the present disclosure.

Reference numerals in the specification are as follows:
Rail vehicle 1; Bogie 10; Wheel 11; Horizontal wheel 12; Third suspension 13; Guiding wheel 15; Stabilizing wheel 16; Chassis 20; Second suspension 21; Vibration damping member 211; First installation portion 212; First support area 22; Wheel avoidance compartment 220; Top plate 221; Side plate 222; End plate 223; Accommodating chamber 22a; Second support area 23; Cab 23a; Load support position 24; Carriage 30; First suspension 31; Second installation portion 32; Platform body 33.

### DETAILED DESCRIPTION

Embodiments of the present disclosure are described in detail below, and examples of the embodiments are shown in the accompanying drawings. The same or similar elements or the elements having same or similar functions are represented by the same or similar reference numerals throughout the description. The embodiments described below with reference to the accompanying drawings are examples, and are to only explain the present disclosure and cannot be construed as a limitation to the present disclosure.

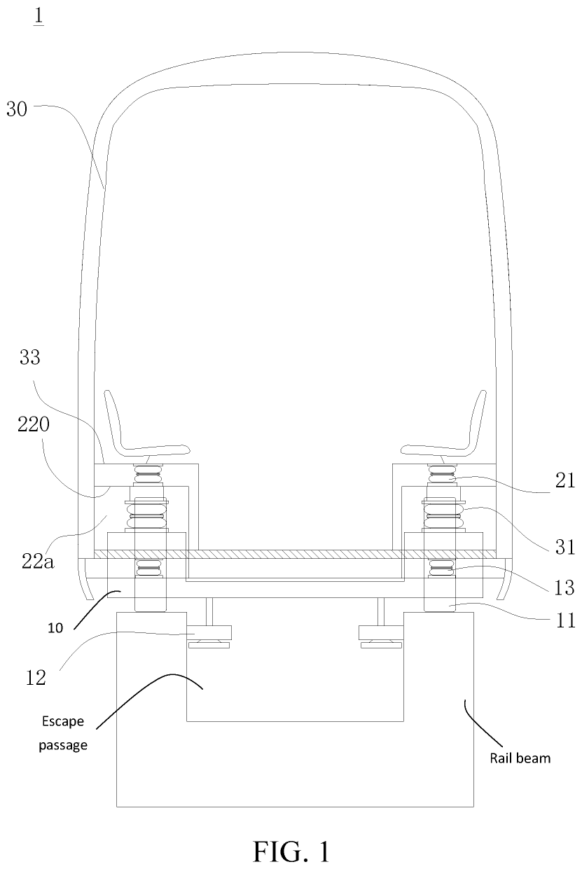

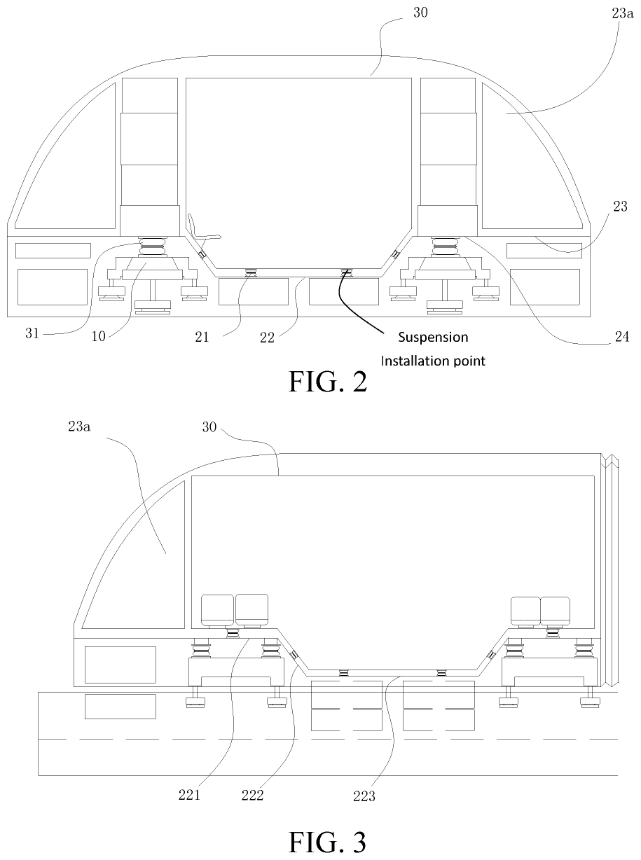

Referring to FIG. 1 to FIG. 6, the following describes a rail vehicle 1 according to the embodiments of the present disclosure. The rail vehicle may a plurality of rubber tires.

As shown in FIG. 1 to FIG. 3, the rail vehicle 1 according to the present disclosure includes a bogie 10, a chassis 20, and a carriage 30. Wheels 11 (e.g., walking wheels) are arranged/disposed on the bogie 10; the chassis 20 is arranged/disposed on the bogie 10 and connected to the bogie 10 through a first suspension 31; and the carriage 30 is arranged/disposed on the chassis 20 and connected to the chassis 20 through a second suspension 21. In some embodiments, the chassis 20 is arranged on the bogie 10 through the first suspension 31, and the carriage 30 is arranged on the chassis 20 through the second suspension 21. The chassis 20 is arranged between the bogie 10 and the carriage 30 to perform vibration damping for the rail vehicle 1. The first suspension 31 and the second suspension 21 may provide a buffering force for the vehicle in a traveling direction of the vehicle and a gravity direction respectively. When the vehicle undergoes speed adjustment, the first suspension 31 and the second suspension 21 perform vibration damping for the vehicle, and a shaking amplitude of the carriage 30 is small, so that the stability of the vehicle is effectively ensured, and the riding comfort of passengers inside the carriage 30 is also improved.

In the rail vehicle 1 involved in the present disclosure, by adding the second suspension 21 between the carriage 30 and the bogie 10, the carriage 30 and the bogie 10 may be separated. In addition, the first suspension 31 is arranged/disposed between the chassis 20 and the bogie 10, and the first suspension 31 and the second suspension 21 may perform vibration damping for the vehicle when the vehicle undergoes speed adjustment, so that the stability problem of the vehicle during high-speed operation is resolved, and a speed increase of the vehicle is no longer limited to the stability of the vehicle.

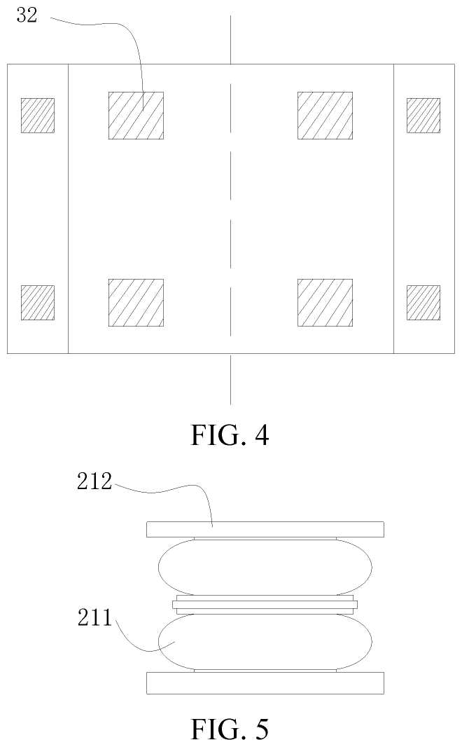

According to some embodiments of the present disclosure, as shown in FIG. 4 and FIG. 5, the second suspension 21 includes a vibration damping member 211, a first installation portion 212, and a second installation portion 32. An end (e.g., a first end) of the vibration damping member 211 is connected to the chassis 20; the first installation portion 212 is arranged at another end (e.g., a second end) of the vibration damping member 211; and the second installation portion 32 is arranged at a bottom of the carriage 30 and detachably connected to the first installation portion 212. In some embodiments, the second suspension 21 is arranged/disposed between the chassis 20 and the carriage 30. The vibration damping member 211 is connected to the chassis 20, the first installation portion 212 of the second suspension 21 is arranged at the another end of the vibration damping member 211, and the second installation portion 32 of the second suspension 21 is arranged at the bottom of the carriage 30, so that the first installation portion 212 and the second installation portion 32 may be fitted and connected to each other to install the carriage 30 on the chassis 20. In some embodiments, a fitting manner of the first installation portion 212 and the second installation portion 32 may be a magnetic absorption connection, a snap-fit connection, a threaded connection, and the like, provided that the fitting manner satisfies a condition that the first installation portion 212 and the second installation portion 32 can be detached. When the first installation portion 212 and the second installation portion 32 are separated, the carriage 30 and the chassis 20 may also be separated, facilitating replacement of the carriage 30. The vehicle may be switched among a passenger car, a freight car, and a passenger and freight mixed car. In addition, for facilitating vehicle maintenance and repairing, when a device in a carriage 30 malfunctions, the entire carriage 30 may be quickly replaced by separating the first installation portion 212 from the second installation portion 32, improving the operation efficiency.

According to some embodiments of the present disclosure, as shown in FIG. 4 and FIG. 5, at least one of the first installation portion 212 and the second installation portion 32 is configured to be a magnetic absorption member. In some embodiments, when the fitting manner of the first installation portion 212 and the second installation portion 32 is magnetic absorption fitting, it is easier to detach and separate the two portions. When the first installation portion 212 is a magnetic absorption member, the second installation portion 32 may be a magnetic absorption member or an iron metal plate; or when the second installation portion 32 is a magnetic absorption member, the first installation portion 212 is a magnetic absorption member or an iron metal plate. In some embodiments, both the first installation portion 212 and the second installation portion 32 are magnetic absorption members.

According to some embodiments of the present disclosure, as shown in FIG. 1 to FIG. 3, the chassis 20 includes a first support area 22 and a second support area 23. Multiple suspension installation points for installing the second suspensions 21 are arranged/configured in the first support area 22. The second suspension 21 is arranged at a suspension installation point corresponding to the second suspension. The carriage 30 is detachably arranged in the first support area 22 by the second suspension 21. The second support area 23 is arranged/configured at a front portion and/or a rear portion of the first support area 22, and a cab 23a is defined by the second support area 23 and a hood. In some embodiments, the carriage 30 may be arranged in the first support area 22 through the second suspension 21. There are multiple suspension installation points and multiple vibration damping members 211 are configured. An end of the vibration damping member 211 is connected to the suspension installation point. Multiple second installation portions 32 are also arranged/disposed at the bottom of the carriage 30. The first installation portions 212 on the multiple vibration damping members 211 are fitted with the multiple second installation portions 32 respectively, and the multiple second mounting portions at the bottom of the carriage 30 are connected to the second suspension 21, making the carriage 30 more stable. In some embodiments, the vehicle has a small cab 23a. The cab 23a is arranged/disposed in an area that is defined by the chassis 20 at an end portion of the vehicle and the hood of the carriage, so that a structure of the vehicle is more compact, and a space that is occupied by the cab 23a may be effectively reduced.

According to some embodiments of the present disclosure, as shown in FIG. 1 to FIG. 3, multiple pairs of wheels 11 are provided, and wheels of each pair are respectively arranged/disposed on two sides of the bogie 10 in a width direction of the rail vehicle. In some embodiments, the wheels 11 of the rail vehicle travel on a rail beam, a cross section of the rail beam is U-shape that is concave in the middle and protrudes on both sides with a consistent height. There are multiple pairs of wheels 11, and wheels 11 of each pair are arranged on the two protruding portions of the rail beam, and the bogie 10 is arranged between the pairs of wheels 11. The wheels 11 are arranged on two sides of the rail beam, so that the vehicle has a better anti-rolling capability, thereby improving the stability of the vehicle during traveling.

In the related art, a diameter of the wheel of a conventional rail vehicle is relatively large. When the wheels are completely arranged under the chassis of the vehicle, a height of the entire vehicle is too high and a center of gravity is unstable. In order to accommodate the wheels while lowering the center of gravity of the vehicle, a wheel avoidance compartment is arranged inside the carriage. The wheel avoidance compartment occupies a large space, affecting walking of passengers, and a volume of the conventional rail vehicle is large, making it difficult to implement development of a miniaturized vehicle.

According to some embodiments of the present disclosure, as shown in FIG. 1 to FIG. 3, a wheel avoidance compartment 220 that protrudes toward the carriage 30 and is configured to accommodate the wheels 11 is formed on each of two sides of the first support area 22 in a width direction of the rail vehicle, and a seat in the carriage 30 is arranged on an upper side of the wheel avoidance compartment 220. In some embodiments, a part of the chassis 20 on the two sides in the width direction is arranged protruding toward the carriage 30, the chassis 20 that protrudes toward the carriage 30 forms the wheel avoidance compartment 220, and a part of the wheels 11 may be accommodated in the wheel avoidance compartment 220. In addition, two sides that are arranged with a seat of the carriage 30 also protrude toward an interior of the carriage 30 to form platform bodies 33. There are multiple seats that are respectively arranged on the platform bodies 33 on the two sides of carriage 30 to fully utilize the space, and the seats may be arranged on a floor of the carriage 30.

The platform body 33 of the carriage 30 and the wheel avoidance compartment 220 of the chassis 20 may be coupled through the second suspension 21. In some embodiments, the wheel avoidance compartment 220 is formed in the first support area 22 of the chassis 20. The wheels 11 are arranged on the two sides of the rail beam. Both left and right wheels can be hidden in the wheel avoidance compartment 220 under the seat, which opens the space in the carriage 30, improves a passenger capacity of the vehicle, and increases a passing width and transparency of the carriage 30. In addition, a part of each of the wheels 11 is located in the vehicle, making an center of gravity of the overall vehicle to be lower, thereby realizing a low-floor rail vehicle.

According to some embodiments of the present disclosure, as shown in FIG. 1 to FIG. 3, the wheel avoidance compartment 220 includes a top plate 221 and a side plate 222. The side plate 222 is connected to an end of the top plate 221 and extends toward the rail beam, the top plate 221 and the side plate 222 define an accommodating chamber 22a configured to accommodate the wheels 11, and the suspension installation points are arranged on the top plate 221 and/or the side plate 222. In some embodiments, the top plate 221, the side plate 222, and an end plate 223 are arranged/disposed in the first support area 22. The top plate 221 and the side plate 222 form the wheel avoidance compartment 220. The side plate 222 that is aslant arranged and connects the top plate 221 that is horizontally arranged and the end plate 223 that is horizontally arranged. The end plate 223 is arranged lower than the top plate 221. When the suspension installation points are arranged on the top plate 221 and the end plate 223, the second suspension 21 may provide a buffering force for the carriage 30 in a gravity direction. When the suspension installation points are arranged on the side plate 222, the second suspension 21 may provide a buffering force for the carriage 30 in a traveling direction of the vehicle and the gravity direction. Therefore, the carriage 30 is more stable during traveling of the vehicle, and the second suspension 21 has a better vibration damping effect.

According to some embodiments of the present disclosure, as shown in FIG. 1 to FIG. 3, the rail beam is provided with a walking surface adapted to support the wheels 11, an escape passage concaving inward is formed on the walking surface, and guiding surfaces are formed on two opposite sides of the escape passage. Horizontal wheels 12, one or more pairs of horizontal wheels 12, are further arranged/disposed on the bogie 10, and each pair of horizontal wheels 12 is supported on the guiding surfaces. In some embodiments, a cross section of the rail beam is in a middle-concave shape, and the concave portion forms the escape passage. Each pair of horizontal wheels 12 is supported on the guide surfaces facing each other inside the escape passage. The arrangement/configuration of the horizontal wheels 12 on the vehicle may improve anti-rolling performance of the vehicle.

According to some embodiments of the present disclosure, as shown in FIG. 1 to FIG. 3, a load support position 24 that is configured to support a load is arranged on the chassis 20. In some embodiments, a load device may be arranged at a load support position, to reduce a weight carried by the carriage 30. In addition, after the load support position is arranged, a structure of the vehicle is more compact, an overall size of the vehicle may be greatly reduced, and vehicle miniaturization may be implemented.

According to some embodiments of the present disclosure, as shown in FIG. 1 to FIG. 3, a third suspension 13 is arranged/disposed between the wheels 11 and the bogie 10. In some embodiments, the bogie 10 is arranged on the wheels 11 through the third suspension 13. The third suspension 13 may provide a buffering force for the bogie 10 when the wheels 11 rotate. According to the rail vehicle 1, by arranging/configuring the first suspension 31, the second suspension 21, and the third suspension 13, the stability problem of the vehicle during high-speed operation of the vehicle may be resolved, and through arrangement of the three suspensions, a speed of the vehicle may not be limited by the stability of the vehicle.

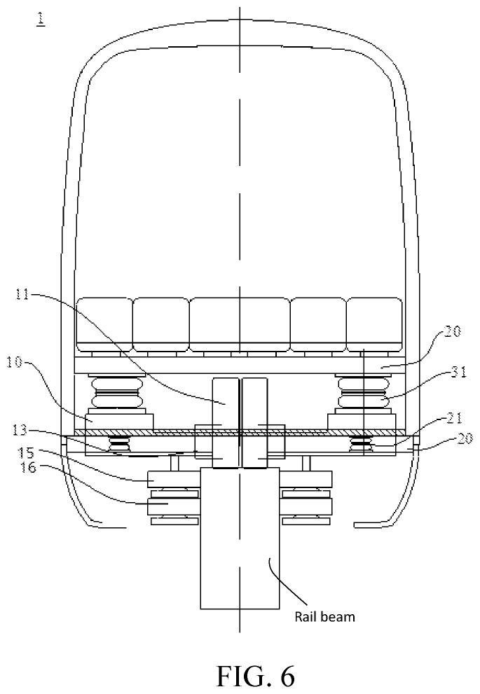

As shown in FIG. 6, the rail vehicle 1 according to the present disclosure may be constructed as a straddle-type rail vehicle. The wheels 11 of the vehicle are arranged on an upper side of the rail beam, and guiding wheels 15 and stabilizing wheels 16 that are located on the two sides of the rail beam are arranged on the bogie 10.

In some embodiments of the present disclosure, the rail vehicle 1 according to the present disclosure includes a bogie 10, a chassis 20, and a carriage 30. The chassis 20 is arranged on the bogie 10 through a first suspension 31, the carriage 30 is arranged on the chassis 20 through a second suspension 21, and the bogie 10 is arranged on wheels 11 through a third suspension 13. The chassis 20 includes a first support area 22 and a second support area 23. A load support position is arranged between the first support area 22 and the second support area 23. A wheel avoidance compartment 220 is formed on each of two sides of the first support area 22 in a width direction of the vehicle. Multiple suspension installation points are arranged on a top plate 221 and a side plate 222 of the wheel avoidance compartment 220. A platform body 33 is formed on each of two sides in a width direction of the carriage 30, and a seat is arranged on the platform body 33. The second suspension 21 includes a vibration damping member 211, a first installation portion 212, and a second installation portion 32. The vibration damping member 211 is arranged at the suspension installation point. The first installation portion 212 is arranged at another end of the vibration damping member 211. The second installation portion 32 is arranged at a bottom of the platform body 33. The first installation portion 212 and the second installation portion 32 are both magnetic absorption members. The carriage 30 and the chassis 20 may be connected through magnetic absorption. There are multiple pairs of wheels 11 and the multiple pairs of wheels are partially located in the wheel avoidance compartment 220. The wheels 11 are arranged on two sides of a rail beam respectively. Two horizontal wheels 12 are supported on a side wall of a guide groove on a guiding surface of the rail beam.

In the rail vehicle 1 in the present disclosure, by adding the second suspension 21 between the carriage 30 and the bogie 10, the carriage 30 and the bogie 10 may be separated. In addition, the first suspension 31 is further arranged between the chassis 20 and the bogie 10, and the first suspension 31 and the second suspension 21 may perform vibration damping for the vehicle when the vehicle undergoes speed adjustment, so that the stability problem of the vehicle during high-speed operation is resolved, and a speed increase of the vehicle is no longer limited to the stability of the vehicle. In addition, a third suspension 13 is further arranged in the vehicle. When the vehicle undergoes speed adjustment, the three suspensions may perform vibration damping for the vehicle, so that a shaking amplitude of the carriage 30 is small, and the stability of the vehicle is ensured. In addition, the carriage 30 and the chassis 20 can be detached, which facilitates replacement of the carriage 30 and is beneficial for maintenance and check of the vehicle, thereby improving the operation efficiency. Two ends of the vehicle are cabs 23a, and a load device is arranged between the cab 23a and the carriage 30, making a structure of the vehicle more compact and a size of the vehicle reduced, thereby implementing vehicle miniaturization. A part of the wheels 11 is arranged in the vehicle, which lowers a center of gravity of the vehicle, realizing a low-floor rail vehicle. The wheel avoidance compartment 220 is arranged under the seat, which does not occupy an interior space of the vehicle and increases a width and a passenger capacity of the carriage 30. Arranging the wheels 11 and the horizontal wheels 12 on left and right sides respectively may improve an anti-rolling capability of the vehicle.

In the description of this specification, description of a reference term such as “an embodiment”, “some embodiments”, “an exemplary embodiment”, “an example”, “a specific example”, or “some examples” means that features, structures, materials, or characteristics that are described with reference to the embodiment or the example are included in at least one embodiment or example of the present disclosure. In this specification, schematic descriptions of the foregoing terms do not necessarily refer to the same embodiment or example. Besides, the features, structures, materials, or characteristics that are described may be combined in a proper manner in any one or more embodiments or examples.

Although the embodiments of the present disclosure have been shown and described, a person of ordinary skill in the art may understand that various changes, modifications, replacements, and variations may be made to the embodiments without departing from the principles and spirit of the present disclosure, and the scope of the present disclosure is as defined by the appended claims and their equivalents.

What is claimed is:

1. A rail vehicle, comprising:
a bogie;
a plurality of wheels being disposed on the bogie;
a chassis disposed on the bogie and connected to the bogie through a first suspension; and
a carriage disposed on the chassis and connected to the chassis through a second suspension.

2. The rail vehicle according to claim 1, wherein the second suspension comprises:
a vibration damping member, wherein a first end of the vibration damping member is connected to the chassis;
a first installation portion disposed at a second end of the vibration damping member; and
a second installation portion disposed at a bottom of the carriage and detachably connected to the first installation portion.

3. The rail vehicle according to claim 2, wherein at least one of the first installation portion and the second installation portion is configured to be a magnetic absorption member.

4. The rail vehicle according to claim 1, wherein the chassis comprises:
a first support area, wherein a plurality of suspension installation points are disposed in the first support area, the second suspension is disposed at a suspension installation point of the suspension installation points, and the carriage is detachably disposed in the first support area by the second suspension; and
a second support area disposed at a front portion and/or a rear portion of the first support area, wherein a cab is defined by the second support area and a hood of the carriage.

5. The rail vehicle according to claim 4, wherein the wheels comprise a plurality of pairs, wheels of each pair are respectively disposed on two sides of the bogie in a width direction of the rail vehicle.

6. The rail vehicle according to claim 4, further comprising a wheel avoidance compartment that protrudes toward the carriage and is configured to accommodate a wheel, wherein the wheel avoidance compartment is formed on a side of the first support area, and at least one seat is disposed on the wheel avoidance compartment.

7. The rail vehicle according to claim 6, wherein the wheel avoidance compartment comprises a top plate and a side plate, the side plate is connected to an end of the top plate and extends toward a rail beam, the top plate and the side plate define an accommodating chamber configured to accommodate a wheel, and one of the suspension installation points is disposed on the top plate or the side plate.

8. The rail vehicle according to claim 6, further comprising:
a pair of horizontal wheels disposed on the bogie, wherein the horizontal wheels are supported on side surfaces of an escape passage of a rail beam.

9. The rail vehicle according to claim 1, further comprising a load support position disposed on the chassis, wherein the load support position is configured to support a load.

10. The rail vehicle according to claim 1, further comprising a third suspension disposed between the wheels and the bogie.

11. A rail system, comprising a rail vehicle and a rail beam, wherein:
the rail vehicle comprises:
a bogie;
a plurality of wheels being disposed on the bogie;
a chassis disposed on the bogie and connected to the bogie through a first suspension; and
a carriage disposed on the chassis and connected to the chassis through a second suspension; and
the rail beam is configured to support the rail vehicle.

12. The rail system according to claim 11, wherein the second suspension comprises:
a vibration damping member, wherein a first end of the vibration damping member is connected to the chassis;
a first installation portion disposed at a second end of the vibration damping member; and
a second installation portion disposed at a bottom of the carriage and detachably connected to the first installation portion.

13. The rail system according to claim 12, wherein at least one of the first installation portion and the second installation portion is configured to be a magnetic absorption member.

14. The rail system according to claim 11, wherein the chassis comprises:
a first support area, wherein a plurality of suspension installation points are disposed in the first support area, the second suspension is disposed at a suspension installation point of the suspension installation points, and the carriage is detachably disposed in the first support area by the second suspension; and
a second support area disposed at a front portion and/or a rear portion of the first support area, wherein a cab is defined by the second support area and a hood of the carriage.

15. The rail system according to claim 14, wherein the wheels comprise a plurality of pairs, wheels of each pair are respectively disposed on two sides of the bogie in a width direction of the rail vehicle.

16. The rail system according to claim 14, wherein
the rail vehicle further comprises a wheel avoidance compartment,
the wheel avoidance compartment protrudes toward the carriage, is configured to accommodate a wheel, and is formed on a side of the first support area, and
at least one seat is disposed on the wheel avoidance compartment.

17. The rail system according to claim 16, wherein the wheel avoidance compartment comprises a top plate and a side plate, the side plate is connected to an end of the top plate and extends toward the rail beam, the top plate and the side plate define an accommodating chamber configured to accommodate a wheel, and one of the suspension installation points is disposed on the top plate or the side plate.

18. The rail system according to claim 16, wherein
the rail beam comprises a walking surface that supports the wheels, and an escape passage concaving downward formed on the walking surface, and
the rail vehicle further comprises a pair of horizontal wheels disposed on the bogie, and the horizontal wheels are supported on side surfaces of the escape passage.

19. The rail system according to claim 11, wherein the rail vehicle further comprises a load support position disposed on the chassis, and the load support position is configured to support a load.

20. The rail system according to claim 11, wherein the rail vehicle further comprises a third suspension disposed between the wheels and the bogie.
